(19) United States
(12) Patent Application Publication
(10) Pub. No.: US 2004/0019877 A1
(43) Pub. Date: Jan. 29, 2004

(54) System, method and program product for initializing variables in a program

(75) Inventors: Jeffrey I. Berkowitz, Woodbury, CT (US); Mohan Peri, Naugatuck, CT (US); Sharon L. Rado, Woodbury, CT (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/206,015

(22) Filed: Jul. 26, 2002

(51) Int. Cl. G06F 9/44

(52) U.S. Cl. 717/117; 717/124

(57) ABSTRACT

A system, method and program product for initializing variables in a program is provided. Specifically, under the present invention, a program code of source code is received as input in a utility. Non-initialized variables within the program are then detected and initialized. Once initialized, the updated program is outputted.

### BACKGROUND OF THE INVENTION

1. Field of the Invention

The present invention generally relates to initialization of variables in a program. Specifically, the present invention relates to detection and initialization of non-initialized variables in a program of source code.

2. Background Art

Many computer programs are written in programming languages such as C, PL/1, COBOL, Java, etc. Typically, computer programs include variables (e.g., character strings, numeric fields, etc.) that must be initialized for the program to execute properly. Although many variables are initialized when the program is written or compiled, many variables are left in a non-initialized form. To initialize such variables, many programmers rely on runtime libraries or utilities such as Language Environment/370 (LE/370). In either case, initialization occurs at execution of the program, which is highly inefficient. Specifically, it is common to observe increases of 30-50% in Central Processing Unit (CPU) time when initializing variables in this manner.

To reduce the CPU time, many programmers update the source code to explicitly initialize each variable. That is, the programmers manually insert initialization statements into the source code for each non-initialized variable. Not only is such manual processing time consuming and error prone, but costly as well.

In view of the foregoing, there exists a need for a system, method and program product for initializing variables in a program. Still yet, a need exists for a program of source code to be updated so that non-initialized variables can be initialized prior to execution. A further need exists for a utility that can receive a program of source code as input, detect non-initialized variables within the source code, insert initialization statements for the non-initialized variables, and output an updated program of source code.

### SUMMARY OF THE INVENTION

In general, the present invention provides a system, method and program product for initializing variables in a program. Specifically, under the present invention, the system (utility) receives a program of source code as input. The system then detects any non-initialized variables within the source code. Once detected, the program is updated by inserting initialization statements into the source code for the non-initialized variables. After initialization, the updated program of source code is outputted.

According to a first aspect of the present invention, a system for initializing a non-initialized variable in a program of source code is provided. The system comprises: (1) a detection system for detecting the non-initialized variable in the program of source code; (2) an update system for updating the program to include an initialization statement for the non-initialized variable; and (3) an output system for outputting the updated program.

According to a second aspect of the present invention, a method for initializing a non-initialized variable in a program of source code is provided. The method comprises: (1) running a utility using the program as input to initialize the non-initialized variable, wherein the utility is adapted to: (a) detect the noninitialized variable; (b) update the program to include an initialization statement for the non-initialized variable; and (c) output an updated program.

According to a third aspect of the present invention, a method for initializing a non-initialized variable in a program of source code is provided. The method comprises: (1) providing a source code program having non-initialized variables; (2) running a utility using the provided source code program as input, the utility adapted to produce an output source code program having initialization statements for the non-initialized variables.

According to a fourth aspect of the present invention, a program product stored on a recordable medium for initializing non-initialized variables in a program of source code is provided. When executed, the program product comprises: (1) program code for detecting the non-initialized variables in the program of source code; (2) program code for updating the program to include initialization statements for the non-initialized variables; and (3) program code for outputting the updated program.

Therefore, the present invention provides a system, method and program product for initializing variables in a program.

### BRIEF DESCRIPTION OF THE DRAWING

These and other features of this invention will be more readily understood from the following detailed description of the various aspects of the invention taken in conjunction with the accompanying drawings in which:

FIG. 1 depicts a computer system having an initialization system according to the present invention.

FIG. 2 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

In general, the present invention provides a system, method and program product for initializing variables in a program. Specifically, under the present invention, a program of source code is received as input. One or more non-initialized variables within the program are then detected and initialized. Once initialized, the updated program is outputted.

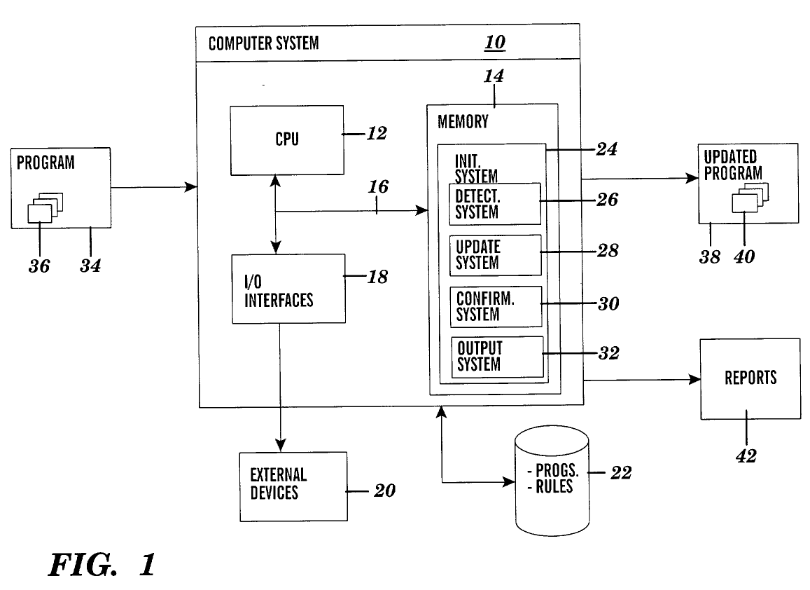

Referring now to FIG. 1, computer system 10 having initialization system 24 is shown. As depicted, computer system 10 includes central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in computer system 10 and likewise may comprise any known type of transmission link, including electrical, optical, wireless, etc. In addition, although not shown, additional components, such as cache memory, communication systems, system software, etc., may be incorporated into computer system 10.

Database 22 may provide storage for information necessary to carry out the present invention. Such information could include, among other things, programs, initialization rules, etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices. It should be understood computer system 10 is intended to be representative of any type of computerized system. Examples include a server, a client, a workstation, a laptop, a personal digital assistant, etc.

Stored in memory 14 of computer system 10 is initialization system 24 (shown as a program product). As shown, initialization system 24 includes detection system 26, update system 28, confirmation system 30, and output system 32. In a typical embodiment, initialization system 24 is a utility, which when loaded on computer system 10, will update input program 34 so that non-initialized variables 36 are initialized. Specifically, program 34 of source code is received by detection system 26. Upon receipt, detection system 26 will analyze the source code to identify any non-initiated variables. As indicated above, variables typically include character strings, numeric fields, etc. Non-initialized variables can generally be detected by the lack of initialization statements. For example, if a variable is a numeric field, and no initialization statement indicating a number that should be inserted into the field is present in the source code, the variable is considered non-initialized. To this extent, detection system 26 could be programmed to search for a particular line of code or type of code for the variables in program 34. If the requisite code is missing, the variable is considered to be non-initialized.

Once the non-initialized variables have been detected, update system 28 will update program 34 by initialization the variables. Specifically, update system 28 will access initialization rules in database 22 to insert initialization statements for the non-initialized variables. In general, the initialization rules indicate which variables should be initialized. For example, the initialization rules could indicate that certain non-initialized variables should be left non-initialized. In addition, the initialization rules correlate the types of variables that should be initialized with the appropriate initialization statements. For example, the rules could dictate that for a character string variable, the string should set to blanks and for a numeric field variable, the field should be set to zeros. In any event, the appropriate initialization statement (e.g., set field to blanks, or set field to zero) will be inserted into the source code of program 34 for the non-initialized variables that need to be initialized.

Once all pertinent non-initialized variables are believed to have been initialized, confirmation system 30 will confirm the results. Specifically, confirmation system will analyze the updated program. If confirmation system 30 detects any non-initialized variables that should have been initialized but were missed, update system 28 will then initialize those variables. Conversely, confirmation system 30 may discover that certain variables were initialized that should have been left non-initialized. In this case, update system 28 will remove the corresponding initialization statements. It should be understood that confirmation of the results as described herein is intended to be illustrative and that many variations are possible. For example, confirmation system 30 could be programmed to determine only whether variables were initialized that should have been left non-initialized, and not whether uninitialized variables were missed.

Once program 34 has been correctly updated, updated program 38 of source code with initialized variables 40 will be outputted via output system 32. Updated program 38 can then be compiled into object code and executed. In addition, to outputting updated program 38, output system 32 could generate and output report 42 pertaining to the update process. For example, report 42 could describe the variables that were initialized, the confirmation results, etc.

In another embodiment of the present invention, program 24 is not updated. Rather, program 24 is analyzed by detection system 26 and a report containing a list of all non-initialized variables that need to be initialized could be generated and outputted. The report could also include the corresponding initialization statements that are required for initialization. Thus, the present invention could perform the same function without actually updating program 34.

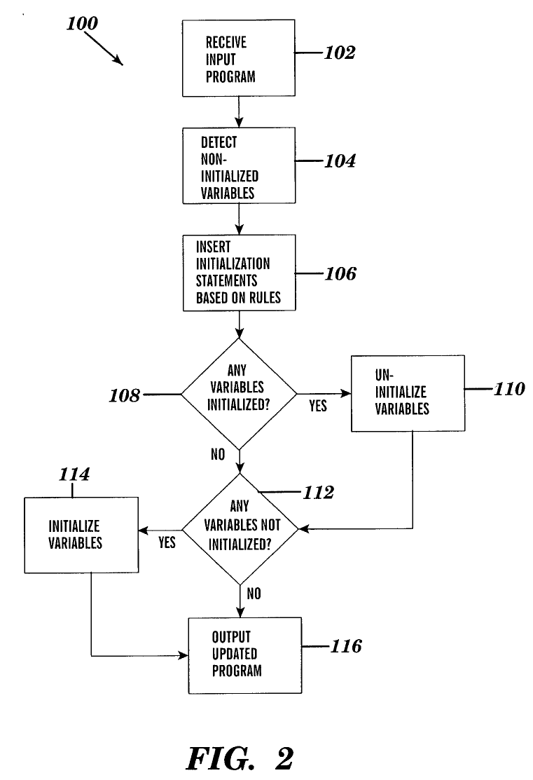

Referring now to FIG. 2, a method flow diagram 100 of the present invention is shown. As depicted, first step 102 of method 100 is to receive an input program of source code. As indicated above, input program 34 typically includes one or more non-initialized variables that need to be initialized. Once received, the program is analyzed to detect the non-initialized variables in step 104. Upon detection, the program will be updated by inserting initialization statements based on the initialization rules in step 106. After insertion, the process will be confirmed. Typically, this includes determining whether any variables were initialized that should have remained non-initialized in step 108. If so, then those variables will be un-initialized in step 110. Then, in step 112, it will be determined whether any non-initialized variables were missed. If variables were missed, they will be initialized in step 114. Lastly, when all appropriate non-initialized variables have been correctly initialized, the updated program will be outputted in step 116.

As indicated above, it should be appreciated that confirmation of results as described in steps 108-114 could take many variations. For example, steps 108 and 110 could be eliminated, while steps 112 and 114 are performed. It is further understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for initializing a non-initialized variable in a program of source code, comprising:
a detection system for detecting the non-initialized variable in the program of source code;
an update system for updating the program to include an initialization statement for the non-initialized variable; and
an output system for outputting the updated program.

2. The system of claim 1, wherein the update system updates the program based upon a set of rules.

3. The system of claim 2, wherein the set of rules correlates the initialization statement with a type of the non-initialized variable, and wherein the program is updated by inserting the initialization statement from the set of rules into the source code of the program.

4. The system of claim 1, further comprising a confirmation system for confirming initialization results.

5. The system of claim 1, wherein the output system further outputs a report describing the updating of the input program.

6. A method for initializing a non-initialized variable in a program of source code, comprising:
running a utility using the program as input to initialize the non-initialized variable, wherein the utility is adapted to:
detect the non-initialized variable;
update the program to include an initialization statement for the non-initialized variable; and
output an updated program.

7. The method of claim 6, wherein the program is updated based upon a set of rules that correlates the initialization statement with a type of the non-initialized variable.

8. The method of claim 7, wherein the program is updated by inserting the initialization statement from the set of rules into the source code of the program.

9. The method of claim 6, wherein the utility is further adapted to confirm initialization results.

10. The method of claim 8, further comprising compiling and running the updated program.

11. A method for initializing variables in a program, comprising:
providing a source code program having non-initialized variables;
running a utility using the provided source code program as input, the utility adapted to produce an output source code program having initialization statements for the non-initialized variables.

12. The method of claim 11, wherein the utility is adapted to:
detect the non-initialized variables in the program;
update the program by including initialization statements for the noninitialized variables; and
output the updated program as the output source code program.

13. The method of claim 12, wherein the utility is further adapted to confirm initialization of the non-initialized variables.

14. The method of claim 11, wherein the non-initialized variables are updated based upon a set of rules, and wherein the set of rules correlate initialization statements with types of non-initialized variables.

15. The method of claim 14, wherein the program is updated by inserting the initialization statements from the set of rules into the source code of the program.

16. The method of claim 11, further comprising compiling the output source code program into an object code program, and running the object code program.

17. A program product stored on a recordable medium for initializing noninitialized variables in a program of source code, which when executed, comprises:
program code for detecting the non-initialized variables in the program of source code;
program code for updating the program to include initialization statements for the non-initialized variables; and
program code for outputting the updated program.

18. The program product of claim 17, wherein the program code for updating updates the program based upon a set of rules.

19. The program product of claim 18, wherein the set of rules correlates the initialization statements with types of non-initialized variables, and wherein the program is updated by inserting the initialization statements from the set of rules into the source code of the program.

20. The program product of claim 17, further comprising program code for confirming initialization of the non-initialized variables.

21. The program product of claim 17, wherein the program code for outputting further outputs a report describing the updating of the input program.
